(19) United States
(12) Patent Application Publication
(10) Pub. No.: US 2024/0223005 A1
(43) Pub. Date: Jul. 4, 2024

(54) DETERMINING OPTIMAL GRID INTERCONNECTIONS

(71) Applicant: X Development LLC, Mountain View, CA (US)

(72) Inventors: Laura Elizabeth Fedoruk, Burlingame, CA (US); Raymond Daly, Palo Alto, CA (US); Amanda McNary, Redwood City, CA (US)

(21) Appl. No.: 18/398,057

(22) Filed: Dec. 27, 2023

Related U.S. Application Data
(60) Provisional application No. 63/477,526, filed on Dec. 28, 2022.

(51) Int. Cl. H02J 13/00; H02J 3/00

(52) U.S. Cl. CPC H02J 13/00002; H02J 3/00; H02J 2203/20

(57) ABSTRACT

Methods, systems, and apparatus, including medium-encoded computer program products, for determining optimal grid interconnections. A power grid model that includes a topological representation of a power grid and electrical specifications of grid components can be accessed. First interconnection data representing a first proposed interconnection to the power grid can be obtained. At least one other proposed interconnection to the power grid can be selected. A modified power grid model can be generated at least by incorporating the first proposed interconnection and the at least one other proposed interconnection into the power grid model. A simulation of the power grid can be executed using the modified power grid model to obtain simulated power grid data. A combined impact of the first proposed interconnection and the at least one other proposed interconnection on the power grid can be determined from the simulated power grid data.

### CROSS-REFERENCE TO RELATED APPLICATION

This application claims priority to U.S. Provisional Application No. 63/477,526, filed on Dec. 28, 2022. The disclosure of the prior application is considered part of and is incorporated by reference in the disclosure of this application.

### TECHNICAL FIELD

This specification relates to electrical power grids, and specifically to evaluating the technical impact of proposed power grid interconnections to determine an optimal set of interconnections, e.g., those providing the most additional clean energy capacity.

### BACKGROUND

Electrical power grids transmit electrical power to loads such as residential and commercial buildings. An interconnection to an electrical power grid can be a generation resource, and may be a renewable energy source. An interconnection to an electrical power grid can also be a new load, such as a new building. Adding interconnections to the electrical power grid can affect conditions of the power grid, and grids can be simulated to determine such impacts.

### SUMMARY

This specification describes technologies that relate to evaluating the technical impact of potential power grid interconnections to determine an optimal set of interconnections to a grid system by simulating the impact of proposed interconnections on an existing power grid. An electrical grid interconnection simulation system can be used, for example, by grid operators such as utilities managing an interconnection queue.

Prior to permitting installation of an interconnection, a grid operator can use a simulation system to simulate electrical grid operation. Since the process of proposing a new interconnect can take multiple years, it is common to have multiple proposed interconnections pending at any given time, and interactions among the proposed interconnections in various combinations can exist. The simulation system described in this specification can determine optimal sites and asset configurations for interconnections to the grid over a longer time horizon and with parallel considerations, including enabling increased hosting capacity. The simulation system can perform interconnection analysis of potential grid configurations that are proposed over a long time horizon (e.g., 5 years, 7 years, 10 years, etc.), including configurations that will exist for limited durations, using various combinations of proposed interconnections, and performing the simulation over a range of conditions and output results, including providing a pass/fail verdict for multiple metrics for each proposed configuration. Based on results of the simulation, the grid operator can determine whether to approve, deny, or modify the proposed combination of interconnections. In some implementations, the grid operator can determine how to allocate grid upgrade costs among multiple proposed interconnections.

Particular embodiments of the subject matter described in this specification can be implemented so as to realize one or more of the following advantages. The techniques described below can be used to determine a recommended combination of proposed interconnections by simulating proposed electrical grid modifications using multiple combinations of proposed interconnections even if a particular combination has not been formally requested in the interconnection queue. Using combined impact assessments from these simulations, a proposed interconnection set with the most favorable impact assessment can be determined. For example, a favorable impact assessment can indicate that implementing the proposed connection set will likely provide technical benefits to the grid, such as improved reliability and/or increased production and use of green energy. For example, a favorable impact assessment for a proposed interconnection set can indicate that proposed interconnections are connected to the electrical grid at locations and in a sequence that can be electrically supported by the present electrical grid. Thus the system can determine the proposed interconnections will likely result in favorable impacts to the operations of the electrical grid, and minimize negative impacts to the operations of the electrical grid. As another example, improvements to the operations of the electrical grid can include changes to battery energy storage charge and discharge profiles, or changes to set points for power electronics.

In addition, the techniques can be used to determine combinations of proposed interconnections that can result in unfavorable states of the electrical grid, and by prohibiting such combinations, protect the integrity of the electrical grid. Further, the techniques of this specification can provide recommendations for addressing predicted safety violations such as revised asset choices and operational characteristics.

In general, innovative aspects of the subject matter described in this specification can be embodied in methods that include the actions of accessing a power grid model that can include a topological representation of a power grid and electrical specifications of grid components; obtaining first interconnection data representing a first proposed interconnection to the power grid; selecting at least one other proposed interconnection to the power grid from among a plurality of different proposed interconnections; generating a modified power grid model at least by incorporating the first proposed interconnection and the at least one other proposed interconnection into the power grid model; executing a simulation of the power grid using the modified power grid model to obtain simulated power grid data with the first proposed interconnection and the at least one other proposed interconnection; and determining, from the simulated power grid data, a combined impact of the first proposed interconnection and the at least one other proposed interconnection on the power grid. Other implementations of this aspect include corresponding systems, apparatus, and computer programs, configured to perform the actions of the methods, encoded on computer storage devices.

These and other implementations can each optionally include one or more of the following features.

In some implementations, the method can include: generating, from at least the first proposed interconnection and the at least one other proposed interconnection, permutations of proposed interconnections.

In some implementations, the method can include: generating a set of modified power grid models for a set of the permutations of proposed interconnections.

In some implementations, executing a simulation of the power grid using the modified power grid models includes executing a simulation of the set of modified power grid models.

In some implementations, determining the combined impact can include applying assessment criteria.

In some implementations, the assessment criteria can include one or more conditions and one or more values.

In some implementations, the assessment criteria can include a machine learning model.

In some implementations, at least one other proposed interconnection shares a feeder with the first proposed interconnection.

In some implementations, an expected implementation date of at least one other proposed interconnection and an expected implementation date of the first proposed interconnection are within a configured time period.

In some implementations, determining the combined impact can include: evaluating a rule by matching a predicted safety violation to a condition specified in the rule; and in response to determining that the predicted safety violation matches the condition, providing a recommended adjustment that is predicted to remediate the predicted safety violation.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of an environment for determining optimal grid interconnections.

FIG. 2 is a flow diagram of an example process for determining optimal grid interconnections.

FIG. 3 is a block diagram of an example computer system.

Like reference numbers and designations in the various drawings indicate like elements.

### DETAILED DESCRIPTION

Adding electrical power grid interconnections can improve the operation of an electrical grid, for example, by adding capacity, including clean and renewable energy sources, such as solar power systems. In addition, since electrical demands evolve, an electrical grid can undergo additions and changes nearly on a continual basis. New buildings, renewable power plants, stationary storage, mobile storage, and expansions to existing buildings, facilities, and loads are some examples of potential changes that can be proposed and made to existing electrical distribution feeders.

One type of interconnection to an electrical power grid is an inverter-connected resource, which takes direct current (DC) (e.g., from solar cells) and converts the DAC to Alternating Current (AC). Inverter-connected resources can include distributed energy resources (DER), which can be small-scale electricity supply resources such as solar units, or power storage resources such as battery storage, that are interconnected to the electric grid.

Before new devices and systems, including inverter-connected resources, are connected to the electrical power grid, it is often necessary to receive permission from the grid operator for the proposed changes. The grid operator ensures that the proposed changes are not likely to cause operation of the electrical distribution feeder to violate any limits or metrics that exist to ensure safe and reliable operation of the electrical power grid. However, electrical power grids are quite complex, and adding an interconnection can cause unexpected or unintended results.

To reduce the likelihood that adverse situations arise, a grid operator, such as a utility, can use an electrical grid interconnection simulation system to determine the impact of adding interconnections. The simulation system can also be used by project developers, property owners, construction companies, and any other involved parties having interest in making additions and/or changes to an electrical power grid. Prior to permitting installation of an interconnection, a grid operator can use the simulation system to simulate electrical grid operation with the proposed interconnection. The simulation system can perform interconnection analysis over a range of conditions and output results including providing a pass/fail verdict for multiple metrics. In some implementations, the simulation system can determine aspects of the grid that should be upgraded to support one or more new interconnections.

Based on the simulation results, the system can evaluate a number of metrics, which can include voltage constraint violations, voltage variability, voltage transients, thermal limits, backfeed constraints, capacity constraints, and overvoltage. In some examples, an evaluation result for each metric may be a “pass” or “fail” result. When outputting a “pass” result, the system can provide margins to operating limits. When outputting a “fail” result, the system can provide the specific failing factors, the timing, frequency, and duration of the failing conditions, and the locations of the failure or failures. The system can also provide recommended changes to the proposed interconnection and/or to the power grid that would be needed to achieve a “pass” result. The recommendations made by the system can include, for example, curtailment, rebuild of electrical assets, addition of storage, voltage controls, amendment of operational parameters, equipment sizing, protection schemes, etc. Thus, simulations enable the grid operator to determine whether to approve, deny, or modify the proposed interconnection.

In addition to evaluating each individual proposed interconnect, the order in which electrical power grid alterations occur, including adding interconnects, can substantially impact grid operation. A project that includes both a solar power interconnect and an upgrade to a feeder can enable subsequent connections of additional clean energy sources, while adding only the clean energy sources without performing the feeder upgrade could impact grid reliability. Since grid operators often consider multiple proposed projects that may each have multiple proposed grid alterations for approval, it can be advantageous to evaluate the impact of each proposed grid alteration as well as the order in which the proposed grid alterations occur over the proposed project and among other proposed projects. Further, when only a subset of proposed projects can be accommodated, it can be useful to select the projects that provide the most technical benefit. For example, a project that provides the most technical benefit can be a project that provides the most renewable energy or the greatest improvement in electrical grid reliability. In some examples, a project that provides the most technical benefit can be a project that provides the greatest improvement in grid reliability without requiring an upgrade to a feeder or other grid components. In some examples, a project that provides the most technical benefit can be a project that includes a new load located relative to a distributed energy resource such that any negative impacts on grid reliability and/or the environment are minimized. Therefore, when multiple projects are being considered, it is advantageous to simulate the electrical grid to determine which configurations provide different types of benefits and impacts on the grid.

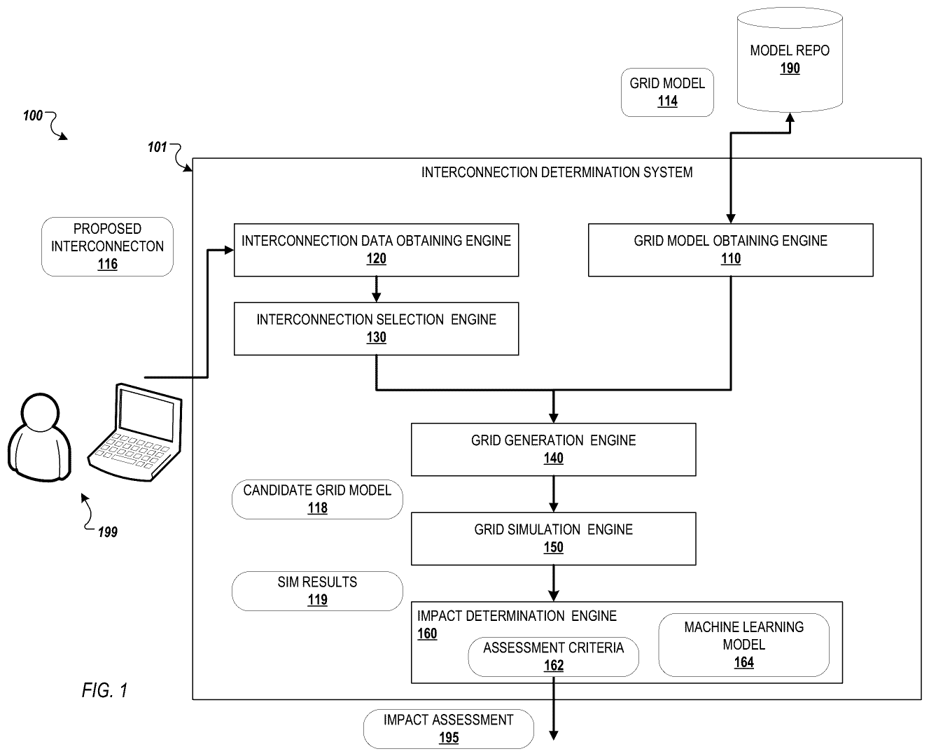

FIG. 1 shows an example of an environment 100 for determining optimal grid interconnections. The environment can include an interconnection determination system 101, a model repository 190 and connection submitters 199.

The model repository 190 can store power grid models 114 (grid models 114, for brevity). The model repository 190 can be any storage system, or collection of storage systems, appropriate for storing grid models. For example, the model repository 190 can include one or more relational databases, object databases, block storage systems, file systems, and so on, and in any combination. The model repository 190 can provide grid models 114 to the interconnection determination system 101.

A power grid can be an electrical power grid that transmits electrical power to loads such as residential and commercial buildings. A power grid model 114 can include a model of real-world power grid assets. The grid model 114 can include a topological representation of the power grid, electrical specifications of grid components, and empirical operation characteristics. Grid models 114 can be specific to a particular geographic region (e.g., a particular city) or electrical region (e.g., particular electrical feeder(s)). The grid model 114 can also optionally include a model of one or more previously proposed interconnections 116 to the power grid, e.g., proposed interconnections 116 that have not yet been built. The detail of the grid model 114 is sufficient to allow for accurate simulation and representation of steady-state, dynamic and transient operation of the grid.

In some examples, the grid model 114 can include a complete electrical model of a feeder to which the proposed interconnection will connect. For example, the grid model 114 can include a high resolution electrical model of one or more electrical distribution feeders. The grid model 114 can include, for example, data models of substation transformers, distribution switches and reclosers, voltage regulation schemes, e.g., tapped magnetics or switched capacitors, network transformers, load transformers, inverters, generators, and various loads. The grid model 114 can include line models, e.g., electrical models of distribution lines. The grid model 114 can also include electrical models of fixed and switched line capacitors, as well as other grid components and equipment.

The line models can include multiple segments that can represent interconnections between poles. In the case of underground lines, the segments can represent interconnections between risers or between underground connections such as transformers and meters. In some examples, the line models can be represented by equivalent inductors and resistors and capacitors for associated line lengths. In some examples, the line models can include models of mutual inductance between lines, capacitance between lines, and capacitance from the lines to ground. Line model attributes can be based on the line's connection type and on the type of conductors used. Line model attributes can also be based on construction details, e.g., whether the lines are overhead or underground.

The grid model 114 can be calibrated by using measured electrical power grid data. The measured electrical power grid data can include historical grid operating data. The historical grid operating data can be collected during grid operation over a period of time, e.g., a number of weeks, months, or years. In some examples, the historical grid operating data can be average historical operating data. For example, historical grid operating data can include an electrical load on a substation during a particular hour of the year, averaged over multiple years. In another example, historical grid operating data can include a number of voltage violations of the electrical power grid during a particular hour of the year, possibly averaged over multiple years, or otherwise represented statistically.

In some examples, the grid model 114 can include default conditions. For example, the grid model 114 can include measured data for certain locations of the power grid, and might not include measured data for other locations. The grid model 114 can use default conditions to interpolate grid operating data for locations in which measurements are not available. A default condition can be, for example, a default ratio or relationship between loads at industrial locations of the power grid compared to residential locations of the power grid, or default conditions for load growth due to climate change.

In some examples, the grid model 114 can include measured data for certain time intervals, e.g., certain hours, and might not include measured data for other time intervals. The grid model 114 can use default conditions to estimate or interpolate grid operating data for time intervals in which measurements are not available. A default condition can be, for example, a default relationship between loads at a particular location at nighttime compared to daytime. In another example, a default condition can be a default relationship between loads at a particular location during an hour of the day in summertime, compared to during the same hour of the day in wintertime.

In some examples, the grid model 114 can include measured data for certain characteristics, e.g., electrical load, and might not include measured data for other characteristics. The grid model 114 can use default conditions to estimate grid operating data for characteristics for which measurements are not available. A default condition can be, for example, a default relationship between load and voltage at a particular location of the power grid.

In some examples, measured data can be used to resolve and reduce errors caused by default conditions in the grid model 114. For example, measured data may conflict with default conditions. The default conditions can be updated based on the measured data. For example, if a default relationship between loads at a particular location during an hour of the day in the summertime conflicts with measured data for a relationship between loads at the particular location during an hour of the day in the summertime, the default relationship can be updated based on the measured data.

In some examples, the grid model 114 can include default conditions that include conservative values in place of missing or incomplete data. In some examples, the grid model 114 can use worst case default conditions to enable worst case analysis.

A proposed interconnection 116 can include interconnection data that specify changes to the electrical power grid that would occur if the proposed interconnection 116 is implemented. A proposed interconnection 116 can include complete electrical models of all elements that will be added to the electrical power grid, indications of any elements that will be removed, and/or complete electrical models of elements that would change as the result of the proposed interconnection 116. Proposed interconnections 116 can also include a wide variety of metadata such as the expected implementation date, the party submitting the proposed interconnection 116, the date by which a response is needed, projected carbon savings and/or other environmental benefits, project priority, and so on.

The interconnection determination system 101 can use electrical grid models 114 and proposed interconnection 116 to simulate the operation of a grid, or a subset of a grid, in light of the proposed interconnections 116 to determine optimal interconnections according to value criteria. The interconnection determination system 101 can include a grid model obtaining engine 110, an interconnection data obtaining engine 120, an interconnection selection engine 130, a grid generation engine 140, a grid simulation engine 150 and an impact determination engine 160.

The grid model obtaining engine 110 can obtain grid models 114 from the grid model repository 190 using any appropriate model retrieval technique. For example, if the model repository 190 includes a relational database, the grid model obtaining engine 110 can use Structured Query Language (SQL) operations to retrieve grid models 114. In another example, if the model repository 190 includes a file system, the grid model obtaining engine 110 can use file system operations to retrieve grid models 114.

In some examples, the grid model obtaining engine 110 can obtain grid models 114 in response to receiving an input. For example, the grid model obtaining engine 110 can obtain grid models 114 in response to receiving a request from a grid operator to evaluate proposed interconnections.

The interconnection data obtaining engine 120 can obtain proposed interconnections 116 from connection submitters 199. A proposed interconnection 116 can include data describing any potential change to existing distribution feeders in a power grid. A distribution feeder distributes power from a substation of a bulk power system to customer loads. The feeder is supplied from a large substation transformer at the substation, and includes load, or network or service, transformers for the distributed loads. The proposed interconnection 116 can be, for example, a new building, renewable power plant, or stationary or mobile power storage facility. The proposed interconnection 116 can further include energy storage, load shifting (e.g., electric vehicle charging; electric water heating; heating, ventilation, and air conditioning (HVAC) adjustments, etc.), and upgraded grid infrastructure (e.g., larger line sizes, transformer upgrades, etc.) The proposed interconnection 116 can also include, for example, an expansion to an existing building, facility, or electrical load. The interconnection data for the proposed interconnection 116 to the power grid can include, for example, a location, a size, a positioning, a power output/load, or a connecting phase of the proposed interconnection 116, a timeline for the connection.

A connection submitter 199 can be any party authorized to submit proposed interconnections 116. Examples of connection submitters 199 can include project developers, property owners, and construction companies, as described above.

The interconnection selection engine 130 can select multiple proposed interconnections 116, and provide the proposed interconnections 116 to the grid generation engine 140. The grid generation engine 140 can apply the proposed interconnections 116 to the grid model 114 to produce a candidate grid model 118 that is used for a simulation. The candidate grid model 118 can be a grid model 114 that represents a grid as it would exist after the proposed interconnections 116 are applied.

For example, the topological representation of the grid model 114 can include a graph representation of the power grid where different types of grid components are represented by different classes, and each grid component is represented by an object of a particular class. The grid generation engine 140 can add an object of a class that defines each proposed interconnection 116 to the grid model 114. For example, each object that defines a proposed interconnection 116 can have attributes defining the proposed interconnection 116, such as the interconnection data. As another example, if a grid model 114 includes a graphical representation of a power grid, the grid generation engine 140 can add icons representing the proposed interconnections 116 to the grid model 114.

The grid simulation engine 150 can run one or more grid simulations using the candidate grid model 118 to produce simulation results 119, and can provide the simulation results 119 to the impact determination engine 160. The impact determination engine 160 can determine a combined impact of applying the proposed interconnections 116 to the electric grid and can provide an impact assessment 195 that reflects the combined impact. For example, the impact determination engine 160 can use assessment criteria 162 to determine the impact assessment 195, as described below. The impact assessment 195 can include one or more impact values that reflect the impact of the proposed interconnections 116. For example, positive impact values can reflect positive impact, and negative impact values can reflect negative impact. In some examples, impact values can be continuous or binary. In some implementations, impact values can reflect a ranking of acceptability of the proposed interconnections. In some implementations, impact values can each represent an impact of the proposed interconnections 116 for a particular factor, such as electrical factors or safety factors. In some implementations, an impact value can represent a combined impact for multiple factors.

Assessment criteria 162 can associate impact assessments 195, or components of impact assessments 195, with properties of proposed interconnections 116 in light of simulation results 119. For example, assessment criteria 162 can state that proposed interconnections 116 that result in safety violations are assigned large negative impact values (e.g., values that are sufficiently negative such that all such proposed interconnections 116 will be rejected), proposed interconnections 116 that result in grid reliability improvements are assigned positive values, and so on. The positive and negative values can be included in the impact assessment 195 and/or the values can be combined to produce a single value for the impact assessment 195, or a lower-order vector of values that summarizes the results.

In some implementations, assessment criteria 162 can include constraints and impact values, such that when constraints are satisfied, impact values are assigned. Constraints can be of any suitable form such as Boolean expressions that can depend on properties of one or more proposed interconnections 116, properties of the grid, simulation results 119 and other data available in the environment. Assessment criteria 162 can be provided to the interconnection determination system 101 by authorized systems administrators. The impact values generated from the assessment criteria 162 can be included in, or used to produce, the impact assessment 195, as described above.

In some implementations, the impact determination engine 160 can determine impact values using one or more trained machine learning models 164 that are configured to provide one or more impact values and/or an impact assessment 195 that reflects the predicted benefit of the proposed interconnections 116. The impact determination engine 160 can process an input that can include any property of the environment (e.g., properties of one or more proposed interconnections 116, properties of the grid, simulation results 119, etc.) using the machine learned model 164 to produce such values and/or an impact assessment 195.

As described above, the impact assessment 195 can include any data relevant to the results of the simulation, which can include values for any electrical characteristics produced by the simulation, including characteristics created during an intermediate stage of the simulation, any criteria that were satisfied or violated during the simulation, including safety criteria, value metrics relevant to the candidate grid model 118, and so on. The impact assessment 195 can be provided to authorized parties, for example, by representing the data in a graphical user interface for display on the user device, providing the data in an appropriate encoding (e.g., in Extensible Markup Language (XML)), storing the data on a storage system (e.g., a file system or database), using other techniques, or using various techniques in combination.

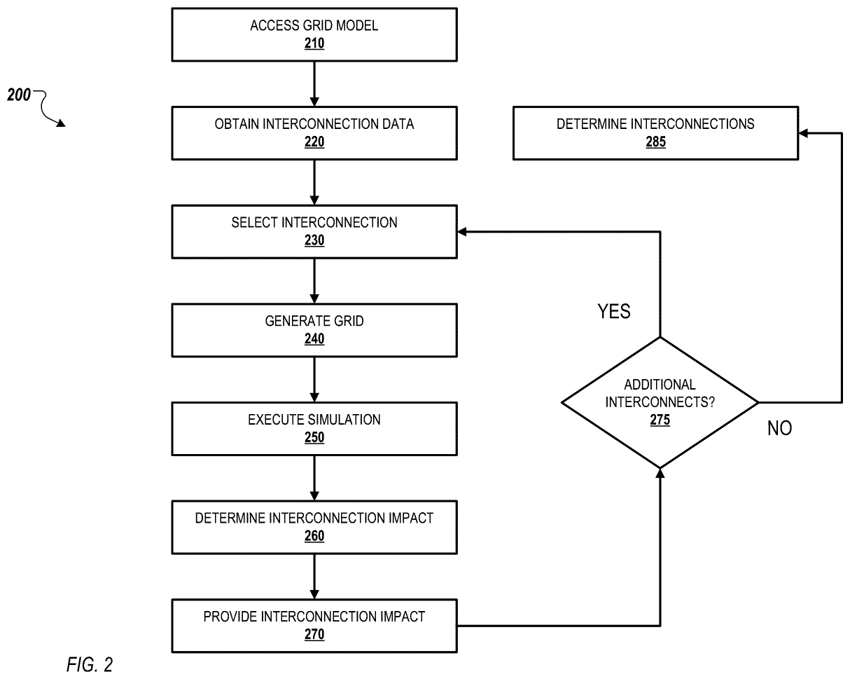

FIG. 2 is a flow diagram of an example process for determining optimal grid interconnections. For convenience, the process 200 will be described as being performed by a system for determining optimal grid interconnections, e.g., interconnection determination system 101 of FIG. 1, appropriately programmed to perform the process. Operations of the process 200 can also be implemented as instructions stored on one or more computer readable media which may be non-transitory, and execution of the instructions by one or more data processing apparatus can cause the one or more data processing apparatus to perform the operations of the process 200. One or more other components described herein can perform the operations of the process 200.

The system can access (210) a grid model that includes a topological representation of a power grid and electrical specifications of grid components. The system can access the power grid model using any appropriate technique. For example, if the grid model is stored on a file system, the system can use file system operations to access the grid model, and if the grid model is stored in a relational database, the system can use SQL operations to access the grid model.

The system can obtain (220) first interconnection data representing a first proposed interconnection to a power grid. In some implementations, the system can include an Application Programming Interface (API) that is configured to accept proposed interconnections that include interconnection data. An authorized submitter can invoke the API to provide the interconnection data to provide one or more proposed interconnections. In some implementations, an authorized submitter can provide the interconnection data to a storage system, and the system can obtain the interconnection data using techniques appropriate for the storage system.

The system can select (230) at least one other proposed interconnection to the power grid from among a plurality of different proposed interconnections. The plurality of different proposed interconnections can be obtained using the techniques of operation 220 or using other suitable techniques. In some implementations, the system can perform the process 200 using the first proposed interconnection (obtained in operation 220) together with other possible arrangements of other proposed interconnections. In some implementations, the system can determine all permutations that include the first proposed interconnect in combination with other proposed interconnections among the plurality of different proposed interconnections. For example, if the first proposed interconnect is denoted A, and proposed interconnections denoted B and C exist, the permutations will include: {A, B}, {B, A}, {A, C}, {C, A}, {A, B, C}, {A, C, B}, {B, A, C}, {B, C, A}, {C, A, B}, and {C, B, A}. Since the order in which the proposed interconnections are connected to the grid may be relevant in some situations, the system can use permutations instead of combinations. In situations where order of connection to the grid is less relevant, the system can simulate different combinations of proposed interconnections. For example, the order can be more relevant in cases where the set of possible interconnections includes different type of interconnections, e.g., load, source and power storage, whereas order can be less relevant if all types of interconnections are the same (e.g., all loads or sources). The order in which storage is added can also matter as once storage is available, any excess storage capacity can be available to other users.

In some implementations, the system can select at least one other proposed interconnection from among proposed interconnections to the same feeder. The feeder(s) indicated in the proposed interconnection obtained in operation 220 can be identified, and compared to the feeder(s) for the proposed interconnection of all other proposed interconnections. When a feeder indicated in the proposed interconnection corresponds to a feeder for another proposed interconnection, the other proposed interconnection can be included in the permutations. By limiting the number of proposed interconnections considered, the system can limit the computational resources required to perform the simulation.

In some implementations, the system can select at least one other proposed interconnection from among proposed interconnections that are proposed to occur within a configured time duration (e.g., 9 months, 12, months, 18 months, etc.). The expected implementation date indicated in the proposed interconnection obtained in operation 220 can be identified, and compared to the expected implementation date of all other proposed interconnections. When the proposed implementation dates are within the configured time duration, the other proposed interconnection can be included in the permutations or combinations. As noted above, by limiting the number of proposed interconnections considered, the system can limit the computational resources required to perform the simulation.

In some implementations, the system will perform the simulation using the first proposed interconnection and a subset of other proposed interconnections. For example, the system can limit combinations to proposed interconnections within a specified distance, which can be a geographic distance or an electrical distance defined by potential interactions among proposed interconnections such that interconnections that will not interact, or whose interaction is sufficiently small as to be negligible, are excluded. In another example, the system can limit combinations of proposed interconnections to a particular load zone, e.g., a zone administered by one operator. In such cases, the system can determine the permutations that include the first proposed interconnection and other proposed interconnections that satisfy the distance threshold.

Once the proposed interconnections have been identified, from among their permutations, the system can select a first permutation. From the first permutation, the system can determine both the other proposed interconnection(s) to be simulated, and the order in which the proposed interconnections will be applied in the simulation(s). The proposed interconnections included in a permutation and used to determine a modified power grid can be called a proposed interconnection set. In various implementations, the system can select the first permutation randomly or pseudo-randomly. The system can select a smaller permutation for the first permutation (e.g., a permutation with only one other proposed interconnection). The system can select successively larger permutations for the following permutations (e.g., a permutation with two or more other proposed interconnections). The system can store an indication that the first permutation has been selected so it is not selected subsequently, and once a permutation has been selected, the permutation can be removed from the list of permutations.

The system can generate (240) a modified power grid model at least by incorporating the interconnections in the proposed interconnection set, which includes the first interconnection and the at least one other proposed interconnection, into the power grid model. The system can modify the grid (obtained in operation 210) by applying the proposed modifications specified by the permutation selected in operation 230. Specifically, the system can generate the modified grid models that will exist after each proposed interconnection in the permutation is applied. For example, if the permutation {A, B} was selected, then a first modified grid model will be produced as a result of applying proposed interconnection A to the grid model, and a second modified grid model will be produced as a result of applying proposed interconnection B to the first modified grid model.

The system can execute (250) a simulation of the power grid using the modified power grid model to obtain simulated power grid data with the first proposed interconnection and the at least one other proposed interconnection. The simulation can be based on, for example, root-mean-square (RMS), power flow, positive sequence, and/or time series voltage transient analysis. In some implementations, the system can simulate only the modified grid model that exists after all proposed interconnections have been applied. In some implementations, the system can simulate each of the multiple modified grid models that are created as the proposed interconnections are applied sequentially. Such a simulation approach provides impact assessments for each stage, capturing both interim benefits and risks that might not be expressed in the final impact assessment. In some implementations, the system can simulate a subset of the multiple modified grid models that are created as the proposed interconnections are applied sequentially.

For each simulation, an interconnection simulation system can conduct comprehensive interconnection evaluations using a reduced set of input data. The interconnection simulation system can perform rapid speed simulation over a variety of dynamic power grid operating conditions over a simulated period of time, e.g., based on historical power grid data. The simulation can include predicted operating conditions over discrete time intervals, e.g., over each hour of a simulated year.

The simulation system can simulate interconnection impacts on the electrical grid under various predicted load conditions, including variations due to factors such as seasonal effects, calendar effects, and time of day effects. The interconnection simulation system can simulate interconnection impacts at multiple locations of the electrical grid. The interconnection simulation system can simulate various electrical operating characteristics, e.g., current, voltage, power factor, load, etc., at multiple locations, over prolonged simulated periods of time.

The amount of data processed during each simulation can depend on the size and framework of the distribution feeder that the proposed interconnection will connect to. The simulation can analyze predicted effects for all connections to the affected distribution feeder and all components of the affected distribution feeder. Thus, the complexity of simulations can vary depending on construction of the distribution feeder.

For example, the simulations can vary depending on length, power, and number of loads of a distribution feeder. A typical distribution feeder can range in length from approximately one mile to ten miles. A typical distribution feeder can range in power from approximately one to ten megawatts. The number of loads connected to a feeder can range from a few hundred residential loads to several thousand residential loads. In some cases, there may also be as few as a few dozen commercial or industrial loads, and as many as hundreds of commercial or industrial loads.

The construction of a distribution feeder can also vary based on location. In urban environments, residential loads typically share transformers. In rural environments, each residential load may have a separate transformer. Commercial and industrial loads are typically served by three-phase transformers. Thus, the number of loads and transformers in a feeder could be as low as a few hundred loads with a few hundred transformers for a rural feeder. The number of loads and transformers in a feeder could be as many as thousands of loads with hundreds of single phase transformers in an urban environment, coupled with dozens or hundreds of larger three phase loads and transformers.

In some examples, the system can simulate operation of multiple feeders. For example, simulations can include analyses of operation of all feeders across a geographic region, e.g., a city, county, province, or state. In some cases, the system can model operation of each individual feeder within the region, and can aggregate the results in order to model operation of the multiple feeders of the region.

In some cases, the system can model operational impacts of multiple feeders on each other. For example, multiple feeders may connect to a shared substation transformer. The system can simulate the impacts of transients of one feeder on another feeder that is connected to the same transformer.

The system can analyze the expected operation of the power grid with the interconnection installed by applying empirical historical data to the grid model with the interconnection installed. The empirical historical data can include historical electrical grid characteristics based on, for example, measurements, calculations, estimates, and interpolations. The characteristics can include, for example, load, voltage, current, and power factor. The empirical historical data can represent power grid operation of multiple interconnected components within a designated geographical area. The empirical historical data can represent average electrical grid operating characteristics over a period of time, e.g., multiple weeks, months, or years.

In some examples, the simulation can analyze the operation of the power grid prior to the addition of the proposed interconnection and after the addition of the proposed interconnection. For example, the system can generate, using the grid model, pre-interconnection simulated power grid data, or simulation results. The pre-interconnection simulation results can include electrical operating characteristics of the electrical power grid over a simulated period of time without the proposed interconnection.

The system can determine (260), from the simulated power grid data, a combined impact for a proposed interconnection set, which will include the first interconnection and the at least one other proposed interconnection on the electric grid. The system can evaluate numerous factors to determine the combined impact. For example, various factors can be determined from the simulated power grid data, such as metrics of improved stability, improved reliability, additional power introduced, safety violations, and so on. Factors can also include information provided in the proposed interconnection, such as carbon saved and other environmental benefits.

The system can include one or more models that map the factors to combined impact. In some implementations, the model can be a linear model in which each factor includes a scaling value. For example, the model can be of the form:

$$CombinedImpact = {\sum }_{i = 1}^{NumFactors} ( {Scale}_{i} * {Factor}_{i} )$$

The scale for safety violations can be set to an arbitrarily large number (e.g., −∞), so that proposed interconnections that result in safety violations will be rejected.

In some implementations, in response to determining that a safety violation is predicted, the system can determine recommended adjustments that are predicted to remediate the violation. The system can include rules that indicate, for each type of safety violation, a corrective adjustment to address the safety violation. Such rules can apply to a wide range of grid components and safety violations, and can be provided to the system as configuration information by a systems administrator or other authorized user.

The type of safety violation can be described by a condition in the rule. For example, a condition can specify a particular type of safety violation (e.g., excessive load) at a type of component of an electrical grid (e.g., transformer), a particular model of a component (e.g., a transformer from a particular manufacturer), a particular make and model of a component (e.g., a particular model of transformer from a particular manufacturer). A rule can also apply to the magnitude of a safety violation (e.g., slight violation of a load limit, large violation of a load limit, etc.), and so on.

The system can evaluate the rules by matching the predicted safety violation from the simulation to the conditions specified in the rules. If multiple conditions match, the system can apply the most specific rule. For example, if one condition specifies a make of transformer, and a second condition specifies a make and model of transformer, and both conditions are satisfied, the system will select the condition that specifies the make and model as it is a more specific description.

The result of the match can be a recommended adjustment. For example, if the safety violation specifies excess load, a recommended adjustment can be to upgrade a transformer or line. In another example, the system can recommend that a new power source be added before a new load. The system can provide the recommended adjustment as a component of an impact assessment, as described further in reference to operation 270.

In some implementations, the model can be a machine learning model that is configured to produce a combined impact. The system can process an input that includes the factors using the machine learning model, and the result can be a combined impact. In some implementations, the combined impact can include one or more values computed using the models, and other factors, such as indications of safety violations or other risks.

The system can provide (270) the interconnection impact using various techniques. For example, the system can store the interconnection impact for the proposed interconnection set on a storage system using techniques appropriate for the storage system, e.g., by using SQL operations to store the interconnection impact in a relational database. In some implementations, the system can provide the interconnection impact as data transmitted to authorized parties. For example, the system can encode the interconnection impact as XML and transmit the XML using any appropriate networking protocol, such as the HyperText Transport Protocol (HTTP) or HTTP-Secure (HTTP-S). In some implementations, the system can provide the interconnection impact as user interface presentation data, which, when rendered by a client device, causes the client device to render a user interface that includes information about the interconnection impact.

In some implementations, the system can determine (275) whether additional proposed interconnection sets require assessment. If so, the system can return to operation 230; if not, the process can proceed to operation 285. In some implementations, the system can consult the list of permutations (created in operation 230), and if the list is non-empty, the system can determine that additional interconnection data does require assessment.

The system can determine (285) recommended proposed interconnections. As described in reference to operation 270, the system can store the combined impact of each evaluated proposed interconnection set. The system can determine, from among the evaluated proposed interconnections sets, the proposed interconnection set with the most favorable combined impact (e.g., the one with the largest combined impact value). The system can provide the recommended proposed interconnections, e.g., using the techniques of operation 270 or similar techniques.

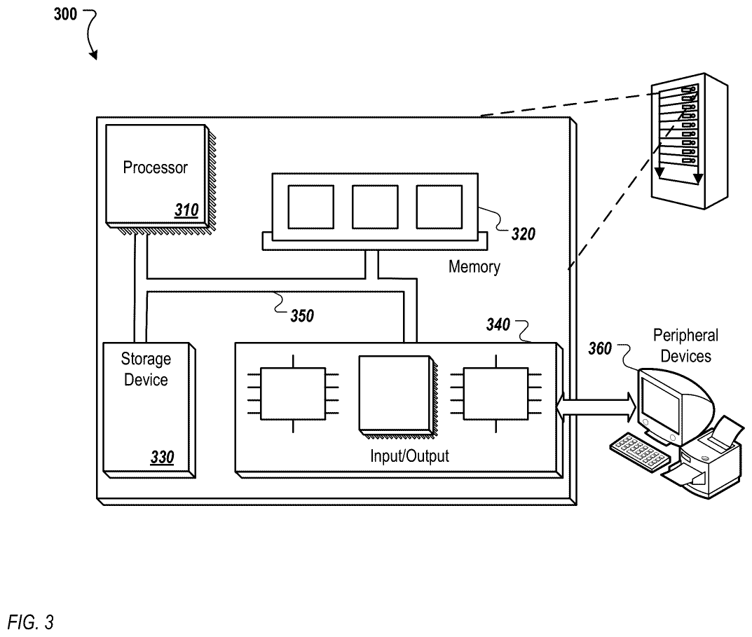

FIG. 3 is a block diagram of an example computer system 300 that can be used to perform operations described above. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, a storage device that is shared over a network by multiple computing devices (e.g., a cloud storage device), or some other large capacity storage device.

The input/output device 340 provides input/output operations for the system 300. In one implementation, the input/output device 340 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 360. Other implementations, however, can also be used, such as mobile computing devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method comprising:
accessing a power grid model comprising a topological representation of a power grid and electrical specifications of grid components;
obtaining first interconnection data representing a first proposed interconnection to the power grid;
selecting at least one other proposed interconnection to the power grid from among a plurality of different proposed interconnections;
generating a modified power grid model at least by incorporating the first proposed interconnection and the at least one other proposed interconnection into the power grid model;
executing a simulation of the power grid using the modified power grid model to obtain simulated power grid data with the first proposed interconnection and the at least one other proposed interconnection; and
determining, from the simulated power grid data, a combined impact of the first proposed interconnection and the at least one other proposed interconnection on the power grid.

2. The computer-implemented method of claim 1, further comprising: generating, from at least the first proposed interconnection and the at least one other proposed interconnection, permutations of proposed interconnections.

3. The computer-implemented method of claim 2, further comprising: generating a set of modified power grid models for a set of the permutations of proposed interconnections.

4. The computer-implemented method of claim 3, wherein executing a simulation of the power grid using the modified power grid models includes executing a simulation of the set of modified power grid models.

5. The computer-implemented method of claim 1, wherein determining the combined impact comprises applying assessment criteria.

6. The computer-implemented method of claim 5, wherein the assessment criteria comprise one or more conditions and one or more values.

7. The computer-implemented method of claim 5, wherein the assessment criteria comprise a machine learning model.

8. The computer-implemented method of claim 1, wherein the at least one other proposed interconnection shares a feeder with the first proposed interconnection.

9. The computer-implemented method of claim 1, wherein an expected implementation date of at least one other proposed interconnection and an expected implementation date of the first proposed interconnection are within a configured time period.

10. The computer-implemented method of claim 1, wherein determining the combined impact comprises:
evaluating a rule by matching a predicted safety violation to a condition specified in the rule; and
in response to determining that the predicted safety violation matches the condition, providing a recommended adjustment that is predicted to remediate the predicted safety violation.

11. A system comprising one or more computers and one or more storage devices storing instructions that when executed by the one or more computers cause the one or more computers to perform operations comprising:
accessing a power grid model comprising a topological representation of a power grid and electrical specifications of grid components;
obtaining first interconnection data representing a first proposed interconnection to a power grid;
selecting at least one other proposed interconnection to the power grid from among a plurality of different proposed interconnections;
generating a modified power grid model at least by incorporating the first proposed interconnection and the at least one other proposed interconnection into the power grid model;
executing a simulation of the power grid using the modified power grid model to obtain simulated power grid data with the first proposed interconnection and the at least one other proposed interconnection; and
determining, from the simulated power grid data, a combined impact of the first proposed interconnection and the at least one other proposed interconnection on the power grid.

12. The system of claim 11, the operations further comprising: generating, from at least the first proposed interconnection and the at least one other proposed interconnection, permutations of proposed interconnections.

13. The system of claim 12, the operations further comprising: generating a set of modified power grid models for a set of the permutations of proposed interconnections.

14. The system of claim 13, wherein executing a simulation of the power grid using the modified power grid models includes executing a simulation of the set of modified power grid models.

15. The system of claim 11, wherein determining the combined impact comprises applying assessment criteria.

16. The system of claim 15, wherein the assessment criteria comprise a machine learning model.

17. The system of claim 16, wherein the at least one other proposed interconnection shares a feeder with the first proposed interconnection.

18. The system of claim 11, wherein an expected implementation date of at least one other proposed interconnection and an expected implementation date of the first proposed interconnection are within a configured time period.

19. The system of claim 11, wherein determining the combined impact comprises:
evaluating a rule by matching a predicted safety violation to a condition specified in the rule; and
in response to determining that the predicted safety violation matches the condition, providing a recommended adjustment that is predicted to remediate the predicted safety violation.

20. One or more non-transitory computer-readable storage media storing instructions that when executed by one or more computers cause the one or more computers to perform operations comprising:
accessing a power grid model comprising a topological representation of a power grid and electrical specifications of grid components;
obtaining first interconnection data representing a first proposed interconnection to a power grid;
selecting at least one other proposed interconnection to the power grid from among a plurality of different proposed interconnections;
generating a modified power grid model at least by incorporating the first proposed interconnection and the at least one other proposed interconnection into the power grid model;
executing a simulation of the power grid using the modified power grid model to obtain simulated power grid data with the first proposed interconnection and the at least one other proposed interconnection; and
determining, from the simulated power grid data, a combined impact of the first proposed interconnection and the at least one other proposed interconnection on the power grid.
